(19) United States
(12) Patent Application Publication
(10) Pub. No.: US 2009/0021110 A1
(43) Pub. Date: Jan. 22, 2009

(54) Method and apparatus for driving a piezoelectric actuator

(76) Inventor: Jeffrey Basil Lendaro, Noblesville, IN (US)

Correspondence Address: Joseph J. Laks;Thomson Licensing LLC, 2 Independence Way, Patent Operations, PO Box 5312, PRINCETON, NJ, 08543, US

(21) Appl. No.: 11/658,622

(22) PCT Filed: Feb. 7, 2005
(86) PCT No.: PCT/US2005/003447

§ 371 Date: Jan. 25, 2007

Related U.S. Application Data
(60) Provisional application No. 60/591,952, filed on Jul. 28, 2004.

(51) Int. Cl. H02N 2/06

(52) U.S. Cl. 310/317

(57) ABSTRACT

Disclosed is an apparatus and a method for differentially driving a piezoelectric actuator (56) in a “smooth pixel” DLP projector (40). Actuator (56) is driven differentially in order to obtain a drive level (VM) that is larger than the available supply voltage (74). Drive is by anti-phase signals (S5,S6), one of which (S5) is DC offset to avoid a negative drive across actuator (56).

### CROSS REFERENCE TO RELATED APPLICATIONS

This application claims benefit of U.S. provisional patent application Ser. No. 60/591,952, filed Jul. 28, 2004, which is herein incorporated by reference.

### FIELD OF THE INVENTION

The field of the present invention generally relates to smooth pixel DLP projection systems and more particularly to piezoelectric actuator drivers.

### BACKGROUND OF THE INVENTION

The background of the present invention is in the area of Digital Light Processing or DLP, which is a type of display technology that projects images onto a large screen for presentations. DLP uses a multitude of very small mirrors disposed on a microchip to selectively control a multitude of individual pixels in a display. The microchip on which the mirrors are disposed is commonly referred to as a Digital Micro-mirror Device (DMD). In its simplest form, white light is transmitted first through a rotating color wheel in order to alternately produce red, green and blue light. The colored light is projected onto the DMD, and the angle of individual mirrors on the DMD is controlled to determine whether or not a pixel associated with a particular mirror appears to be illuminated on the display screen.

An enhanced version of DLP that is known in the art is sometimes referred to as “smooth pixel” DLP. With smooth pixel DLP, the angle of a “dithering” mirror in the DLP image light path is changed in order to increase the effective resolution. Referring to FIG. 1, a first array of pixels 10 is produced by positioning the “dithering” mirror at a first angle. Similarly, a second array of pixels 20, as shown in FIG. 2, can be produced by positioning the “dithering” mirror at a second angle. By selecting the angle of the “dithering” mirror, the diamond pixels for the second set of pixels are shifted downward by half a pixel relative to the first set of pixels. This results in the second set of pixels being centered on the interstices of the first set of pixels. This effect is illustrated by array 30 in FIG. 3. Typically, a piezoelectric actuator, sometimes referred to as a piezoelectric motor, is used to position the angle of the above mentioned “dithering” mirror.

FIG. 4 shows a block diagram of the electrical and optical paths of a typical projection system 40 utilizing smooth pixel DLP. Light from a light source 42 is transmitted through optical elements 44, 48 and a rotating color wheel 46. The color wheel 46 alternately produces red, green and blue light. The colored light is projected onto DMD 50. The angle of individual mirrors 52 on the DMD and the dwell time of each mirror is controlled by processor 72 to determine the degree to which a pixel associated with a particular micro-mirror appears to be illuminated on the display screen 58. Light reflected from DMD 50 is projected to dithering mirror 54 and then is displayed on projection screen 58. By changing the angle Θ₁, Θ₂ of dithering mirror 54 to the light path by actuator 56, the diamond pixels 10 are shifted downward by one-half pixel, resulting in a second array of pixels 20 centered on the interstices of the previous set of pixels as was shown in FIG. 3. Input video signals 64 are manipulated in filters 66-70 and sent to processor 72 to control the micro-mirrors in DMD 50.

The principle of operation of the piezoelectric actuator is that piezoelectric crystals can be used to create motion by driving them with an electric current and harnessing the expansion and contraction of the crystal. The crystal is usually mounted in an aluminum holder in such a way that the expansion of the crystal deflects the holder. This deflection can move a mirror or even be translated to rotational motion. In a particular projection TV application, the dithering mirror needs to be rotated only 0.013 degree to shift the pixels the desired one-half pixel height. In manufacturing a piezo actuator, the crystal must be “polarized” by ramping a relatively high voltage over several seconds. This voltage is typically 45 volts with a duration of 60 seconds. When driving the piezo crystal in an application at over 20 volts peak to peak “de-polarization” can occur if the voltage is allowed to swing in the reverse direction.

FIG. 5 shows a simple manner of driving actuator 56, one that may be referred to as a “Half-Bridge” driver. In the half-bridge driver, actuator 56 is connected between ground and switch 76 such that actuator 56 is alternately connected between voltage source 74 and ground. This applies a voltage VM, in this instance denoted as 80′, across actuator 56. The resulting waveform is shown in FIG. 9 and can be seen to encompass zero to +12 volts, the value of voltage source 74. This can be an effective way to drive actuator 56, except that typical actuators require approximately 24 volts to operate, and typical video systems operate from 12 volt supplies.

FIG. 6 depicts what may be referred to as a “Full-Bridge” driver. This circuit drives the actuator in a differential mode by virtue of adding another switch 82. Switch 82 operates 180 degrees out of phase with switch 76, that is to say that when switch 76 connects one terminal of actuator 56 to +12 volts, switch 82 connects the second terminal to ground and, conversely, when switch 82 connects the actuator to ground, switch 76 connects the actuator to +12 volts. The differential drive voltage V_{M}, in this instance referred to as 80″, is applied across actuator 56. FIG. 10 depicts drive voltage 80″ as going from −12 volts to +12 volts. This provides the requisite 24 volts peak to peak but has the problem of placing a negative voltage across actuator 56. It is clear that a different solution is required to simultaneously satisfy both the necessary drive voltage. without allowing a negative voltage to be impressed across the actuator.

### SUMMARY OF THE INVENTION

To summarize, embodiments provide both apparatus and methods. In one embodiment an apparatus is described which comprises means for generating a first, a second and a third signal, the first signal encompassing a first range, the second signal encompassing a second range and being of a different phase than the first signal and the third signal being generated by level shifting the second signal to a DC bias at a different level from the DC bias of the first and second signals, and means for differentially driving a load from the first signal and third signal. The load in some embodiments may be an actuator or a motor. In an associated embodiment, the first signal and second signals may be binary pulse trains, often duty-cycle modulated pulse trains, or the first signal and second signal may be analog signals. Level shifting of the second signal may, in some embodiments utilize a peak clamp, which may be a negative peak clamp which is referenced to the same level as the positive-most excursion of the second signal. Another embodiment is a method of providing a differential output signal comprising the steps of generating a first signal, generating a second signal, the second signal being out of phase with the first signal, level shifting the second signal to generate a third signal, the third signal being biased differently from the second signal, and providing the first signal and the third signal as differential outputs. Another embodiment is an apparatus for generating differential drive signals which comprises a first switch configured to alternately connect a first signal of a pair of differential signals between a first level and a second level, a second switch configured to alternately connect to the second level and to the first level to generate an intermediate signal, a DC restorer connected to the output of the second switch to level shift the intermediate signal to create a second signal of the pair of differential signals, the second signal being level shifted to operate between a third level and a fourth level. In some applications the fourth level is equal to the second level. Another embodiment describes a differential signal source comprising a signal source, an inverting amplifier whose input is connected to an output of the signal source and whose output is connected to a first output of a pair of differential signals, a level shifter whose input is connected to the output of the signal source and whose output is connected to a second output of the pair of differential signals. Yet another embodiment is apparatus comprising a source of supply voltage, a source of a first signal having a first DC level and a first phase and a second signal having a second phase which is different from the first phase and having a second DC level different from the first DC level, and first and second signal paths for providing said first and second signals, respectively, to a load for producing a drive level at the load which is greater than the magnitude of the supply voltage and for substantially preventing polarity reversal at the load.

### BRIEF DESCRIPTION OF THE DRAWINGS

Embodiments of the present invention will be described below in more detail, with reference to the accompanying drawings in which similar elements in each figure have the same reference designator:

FIG. 1 represents an array of a first set of pixels;

FIG. 2 represents an array of second set of pixels;

FIG. 3 represents an overlay of the first and second sets of pixels;

FIG. 4 is a block diagram of a DLP projector using smooth pixel processing;

FIG. 5 is a block diagram of a “Half Bridge” motor driver;

FIG. 6 is a block diagram of a “Full Bridge” motor driver;

FIG. 7 is a block diagram of an alternative apparatus for driving a piezo actuator;

FIG. 8 is a block diagram of a “Full Bridge” motor driver with DC bias;

FIG. 9 shows a waveform of the motor drive voltage of the driver of FIG. 5;

FIG. 10 shows a waveform of the motor drive voltage of the driver of FIG. 6;

FIGS. 11 through 14 show waveforms-at various nodes of the driver of FIG. 7;

FIGS. 15 through 18 show waveforms at various nodes of the driver of FIG. 8;

FIG. 19 is a schematic of the preferred embodiment of FIG. 8; and

FIG. 20 is a flowchart detailing a method embodiment.

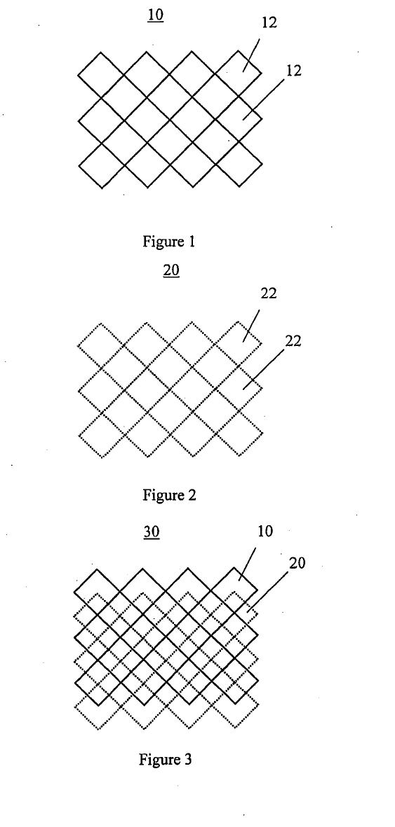

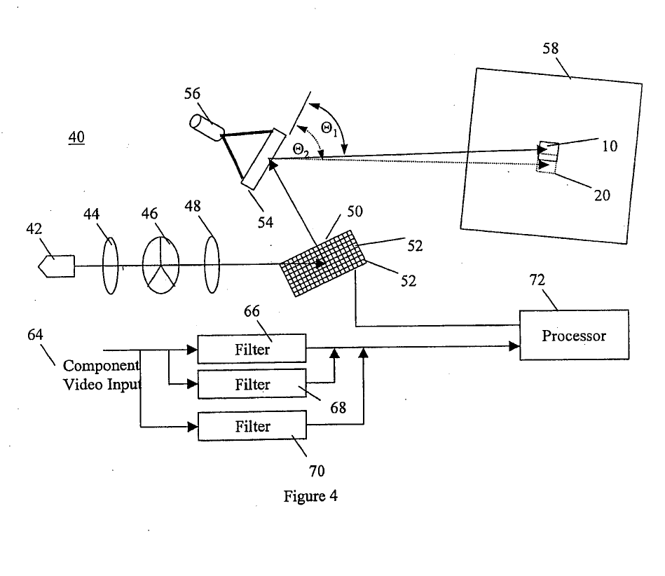

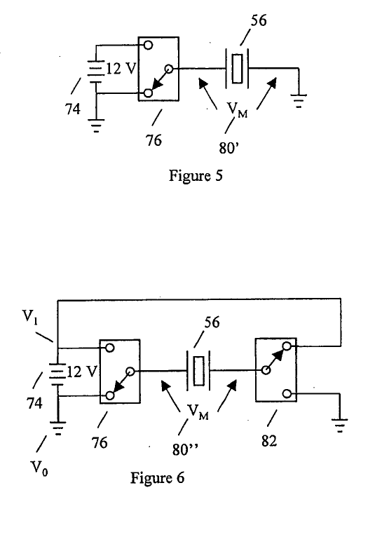

### DETAILED DESCRIPTION

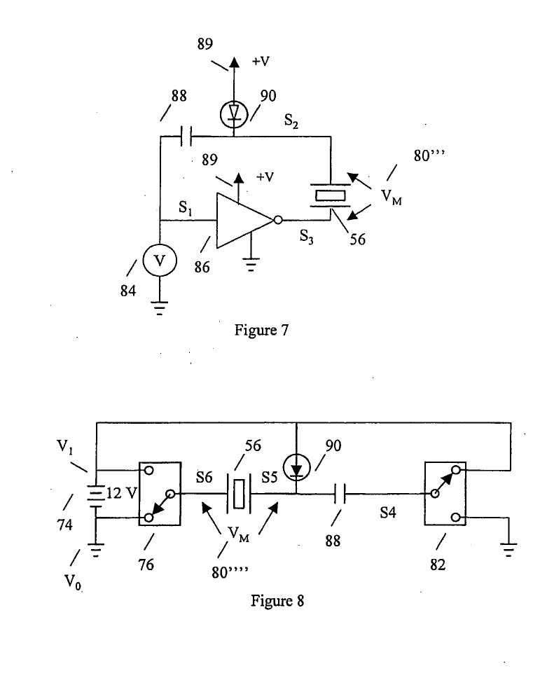

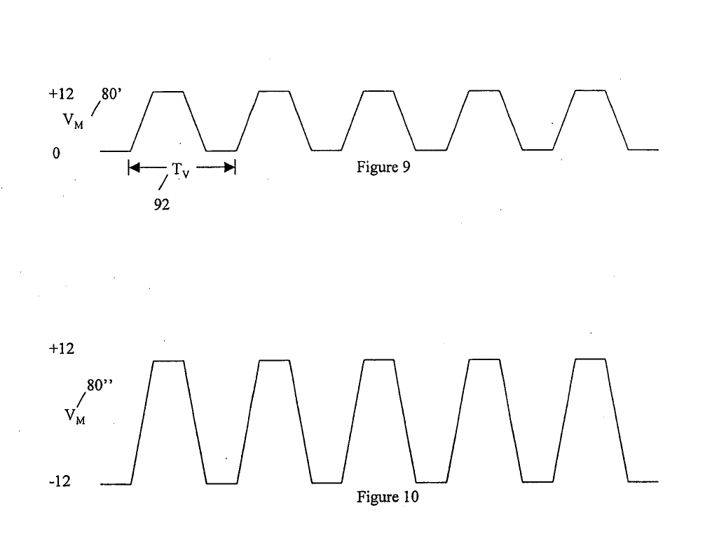

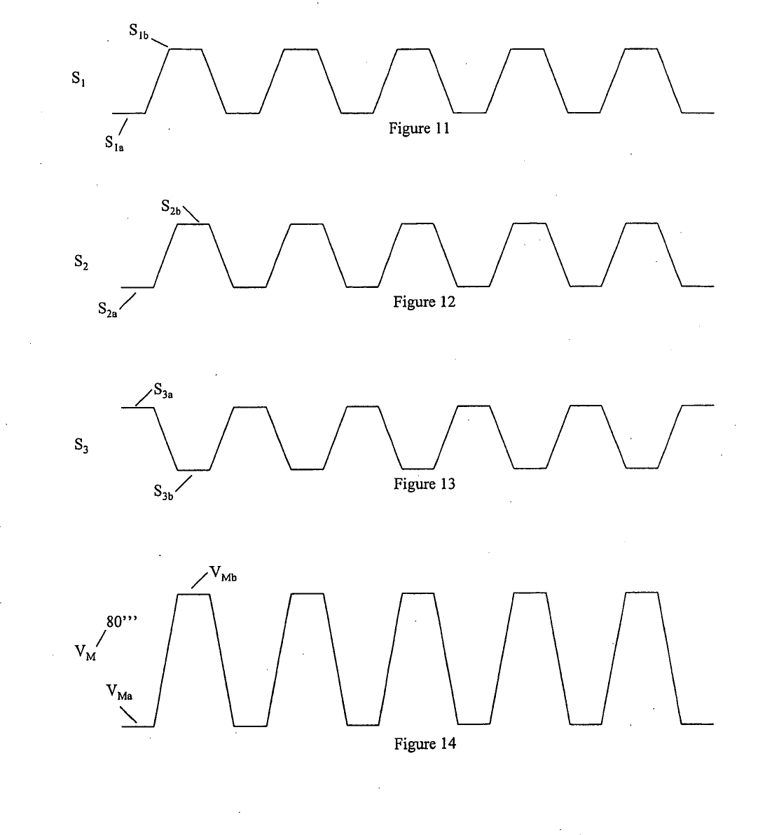

A detailed description of solutions to the problem of driving a piezo actuator with a supply voltage that is lower than the required drive voltage and still not presenting a negative potential across the actuator is shown starting with FIG. 7. In this embodiment, signal source 84 provides a signal to both inverting amplifier 86 and to a negative peak clamp formed by capacitor 88 and diode 90. The available supply voltage 89 powers amplifier 86 and also provides the clamp reference voltage. As shown in FIG. 11, S₁ represents the signal from source 84 and S₁ₐ and S_{1b} represent levels of S₁ at successive intervals of time. In FIG. 12, S₂ represents the signal S₁ as level shifted by clamp 88, 90 and S₂ₐ and S_{2b} represent levels of S₂ at successive intervals of time. In a similar manner, FIG. 13 depicts S₃ as the inverted version of signal S₁, with S₃ₐ and S_{3b} representing levels of S₃ at successive intervals of time. It should be noted that inverting amplifier 86 may also amplify or attenuate S₁ in addition to inverting S₁ to generate S₃. The drive to actuator 56 is the difference signal V_{M}, in this instance denoted as 80″′, which may be expressed as S₂ minus S₃. The resulting drive to actuator 56 is shown in FIG. 14 where the levels of V_{M} during time intervals “a” and “b” may be expressed as:

V_{Ma}=S₂ₐ−S₃ₐ and

V_{Mb}=S_{2b}−S_{3b}.

If amplifier 86 is a unity gain inverter:

S₁ₐ=S_{3b} and

S_{1b}=S₃ₐ

### And if:

S₁ₐ=0 then S_{3b}=0

If V_{REF} is set to be equal to one diode voltage above the positive-most excursion of signal S₁ then, due to the negative peak clamp:

S₂ₐ=S_{1b} and

S_{2b}=S_{1b}+S_{1b}S₁ₐ2=2S_{1b}

Then drive 80″′ will be:

V_{Ma}=S₂ₐ−S₃ₐ=S_{1b}−S_{1b}=0 and

V_{Mb}=S_{2b}−S_{3b}=S_{2b}−0=2S_{1b}

Thus, as shown in FIG. 14, actuator drive can be twice the available supply voltage 89 without experiencing any negative drive potential. It should be obvious to one skilled in the art that by choice of non-unity gain for inverter 86 and/or different levels of clamp reference V_{REF} and/or a different DC component on signal S₁ₐ, the actuator drive can be scaled to have some positive or negative offset, V_{Ma} <>0, or a “gain factor”, 2 in the above example, of a value other than 2.

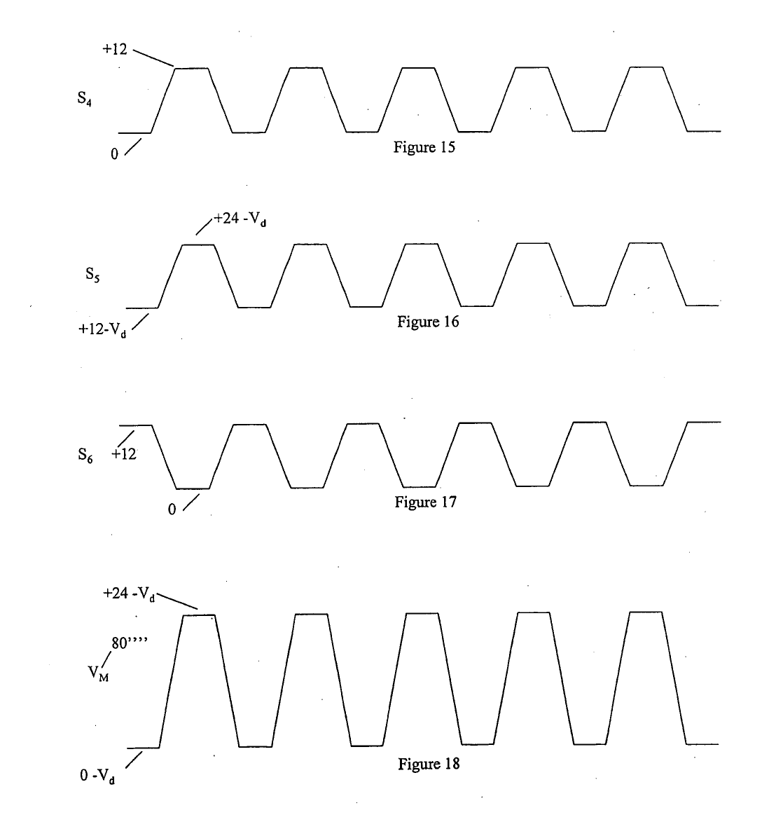

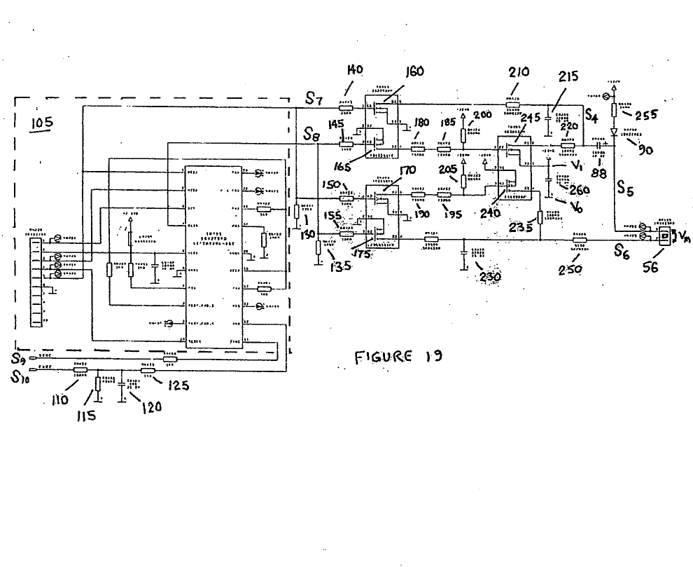

Another embodiment of the actuator drive apparatus is shown in FIG. 8. This embodiment has some similarity to the “full-bridge” driver of FIG. 6, but avoids the negative potential problem mentioned with regard to FIG. 6. The “full-bridge with DC bias” driver of FIG. 8 interposes a DC restorer in the form of a negative peak clamp formed by capacitor 88 and diode 90 between switch 82 and actuator 56. By having the clamp diode 90 anode connected to the same supply voltage source 74 as is applied to switches 76 and 82, a drive voltage 80″″ that is twice the available supply is obtained with only a diode voltage negative component. This negative component is small enough to be negligible. The circuit of FIG. 8 utilizes single-pole double-throw switches 76 and 82 that are actuated by opposite phase actuation, that is, when switch 76 is closed to +12 volts V₁, switch 82 is closed to ground V₀. Alternately, when switch 76 is closed to ground V₀ switch 82 is closed to +12 volts V₁. Representative waveforms at nodes in the circuit of FIG. 8 are shown in FIGS. 15 through 18. FIG. 15 shows a representative output of switch 82, S₄, and FIG. 17, the output of switch 76, S₆. The clamp comprising capacitor 88 and diode 90 level shift signal S₄ to swing between approximately +12 volts and +₂₄ volts producing the waveform S₅ as shown in FIG. 16. The drive signal applied to actuator 56 is the arithmetic difference between signals S₆ and S₅ which is shown as VM (80″″) in FIG. 18.

FIG. 19 depicts in detail the preferred embodiment of the actuator driver. Micro processor 105 generates two anti-phase drive signals S₇ and S₈. Drive signals S₇ and S₈ are pulse-width modulated digital pulse trains, the average values of which are approximately trapezoidal waveforms that ultimately will be used to provide drive signals S₄, S₅ and S₆. Signal S₇ drives n-channel FET switch 160 on or off through gate drive resistor 140 and S₇ also drives n-channel FET switch 170 on or off through its gate drive resistor 150. Signal S₈ drives n-channel FET switch 165 on or off through gate drive resistor 145 and S₈also drives n-channel FET switch 175 on or off through its gate drive resistor 155. Resistors 140, 145, 150 and 155 are included to reduce electromagnetic interference, EMI, that might be caused by fast switching of the FETs. FET 170 is operated as an inverter to drive p-channel FET 240 through a resistive divider comprising resistors 190, 195 and 205. FET 165 is operated as an inverter to drive p-channel FET 245 through a resistive divider comprising resistors 180, 185 and 200. Series resistor combinations 180-185 and 190-195 are configured as the input arm of their respective dividers in order to reduce power dissipation in the series arm of the dividers. The combination of n-channel FET 160 and p-channel FET 245 comprise the single-pole double-throw switch 82 of FIG. 8. The combination of n-channel FET 175 and p-channel FET 240 comprise the single-pole double-throw switch 76 of FIG. 8. Since signals S₇ and S₈ are duty-cycle modulated pulse trains, the outputs of complementary FETs 160 and 245 are summed together by resistors 210 and 220 and low-pass filtered by capacitor 215 to generate the analog drive waveform S₄. The outputs of complementary FETs 175 and 240 are summed together by resistors 225 and 235 and low-pass filtered by capacitor 230 to generate the analog drive waveform S₆. Sync input signal S₉ is a vertical synchronizing signal used by micro processor 105 to synchronize drive signals S₇ and S₈ to alternate phase at a vertical rate. Signal S₁₀ is a duty-cycle modulated waveform generated by a system controller, not shown, and scaled in amplitude by resistors 110 and 115 and filtered to a DC value by capacitor 120. This DC voltage is used by micro processor 105 to adjust the amplitude of drive signals S₇ and S₈, which allows for adjustment of the deflection of actuator 56 and thus the mirror being driven by the actuator. Capacitor 260 is a bypass capacitor to filter supply voltage V₁.

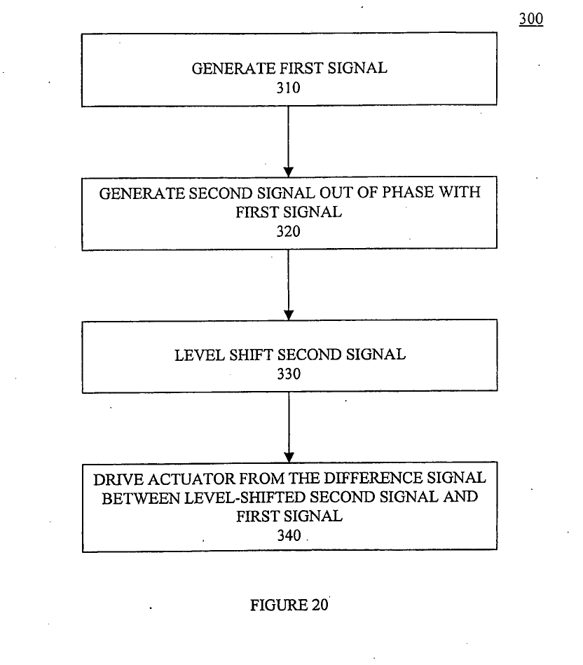

FIG. 20 shows a flowchart 300 which details the steps of a method of driving an actuator or motor. The first step 310 is to generate a first signal. The next step 320 is to generate a second signal which is out of phase with the first signal. The second signal is then level shifted in step 330 and the final step 340 is to drive the load differentially with the level shifted second signal and the first signal.

While the present invention has been described with reference to the preferred embodiments, it is apparent that various changes may be made in the embodiments without departing from the spirit and the scope of the invention, as defined by the appended claims.

1. Apparatus comprising:
Means (74, 76, 82, 88, 90) for generating a first (S₆), a second (S₄) and a third (S₅) signal, said first signal (S₆) encompassing a first range, said second signal (S₄) encompassing a second range and being of a different phase than said first signal (S₆) and said third signal (55) being generated by level shifting (88, 90) said second signal (S₄) to a DC bias at a different level from the DC bias of said first (S₆) and said second signals (S₄); and
means (S₅, S₆) for differentially driving a load (56) from said first signal (S₆) and said third signal (S₅).

2. Apparatus as in claim 1 wherein said means for generating said first signal and said second signal generates said first and said second signals as binary pulse trains.

3. Apparatus as in claim 1 wherein said means for generating said first signal and said second signal generates said first and said second signals as analog signals.

4. Apparatus as in claim 1 wherein said generating means level shifts said second signal utilizing a peak clamp (88, 90).

5. Apparatus as in claim 1 wherein said load comprises an actuator (56).

6. Apparatus as in claim 2 wherein said generating means generates said first and said second signals as duty-cycle modulated pulse trains.

7. Apparatus as in claim 4 wherein said generating means level shifts said second signal utilizing a negative peak clamp, said negative peak clamp being referenced to the same level as the positive-most excursion of said second signal.

8. A method for providing a differential output signal comprising the steps of:
generating a first signal;
generating a second signal, said second signal being out of phase with said first signal;
level shifting said second signal to generate a third signal, said third signal being biased differently from said second signal; and
providing said first signal and said third signal as differential outputs.

9. A method of providing a differential output signal as in claim 8 wherein said first signal and said second signal are duty-cycle modulated pulse trains.

10. A method of providing a differential output signal as in claim 8 wherein said first signal and said second signal are analog signals.

11. A method of providing a differential output signal as in claim 8 wherein said level shifting of said second signal utilizes a peak clamp.

12. A method of providing a differential output signal as in claim 11 wherein said level shifting of said second signal utilizes a negative peak clamp, said negative peak clamp being referenced to a positive polarity reference level.

13. Apparatus for generating differential drive signals comprising:
a first switch (74) configured to alternately connect a first signal (S₆) of a pair of differential signals (S₆, S₅) between a first level (V₀) and a second level (V₁);
a second switch (82) configured to alternately connect to said second level (V₁) and to said first level (V₀) to generate an intermediate signal (S₄); a DC restorer (88, 90) connected to said second switch (82) to level shift said intermediate signal (S₄) to create a second signal (S₅) of said pair of differential signals, said second signal (S₅) being level shifted to operate between a third level and a fourth level.

14. Apparatus as in claim 13 wherein said fourth level is equal to said second level.

15. A differential signal source comprising:
a signal source (84);
an inverting amplifier (86) whose input is connected to an output of said signal source (84) and whose output is connected to a first output (S₃) of a pair of differential signals (S₃, S₂);
a level shifter (88, 90) whose input is connected to said output of said signal source (84) and whose output is connected to a second output (S₂) of said pair of differential signals.

16. The differential signal source as in claim 15 wherein said level shifter is a DC restorer.

17. The differential signal source as in claim 15 wherein the negative peak value of one of said first signal or said second signal of said pair of differential signals is equal to the positive peak value of the other one of said first signal or said second signal of said pair of differential signals.

18. Apparatus comprising:
a source of supply voltage (89);
a source of a first signal (S₁) having a first DC level and a first phase and a second signal (S₂) having a second phase different from said first phase and having a second DC level different from said first DC level; and
first and second signal paths for providing said first and second signals, respectively, to a load (56) for producing a drive level at said load greater than the magnitude of said supply voltage (89) and for substantially preventing polarity reversal at said load.
